(19) United States
(12) Patent Application Publication
(10) Pub. No.: US 2007/0256723 A1
(43) Pub. Date: Nov. 8, 2007

(54) Super structure for roof patio solar plant (II)

(76) Inventor: Eugene Oak, Los Angeles, CA (US)

Correspondence Address: Eugene Oak, Phd., J.D., M.Div., 610 S. Van Ness Ave., Los Angeles, CA, 90005, US

(21) Appl. No.: 11/418,161

(22) Filed: May 5, 2006

(51) Int. Cl. H02N 6/00

(52) U.S. Cl. 136/244; 136/251

(57) ABSTRACT

Supporting frame structure for installing plain solar cell module plates and incidental facilities on a house roof is provided. The supporting structure is in the shape of pluralities of slope structured solar cell plate mount accompanied by cleaning accesses mounted on a rectangular cube frame. Side view of the solar cell plate mount forms a rectangular triangle on a square. The angle between the sloped top surface and the horizontal base is 3 to 75 degrees, depending on the latitude of the geometric location of the place where the solar cell plate modules are installed. Pluralities of ‘T’ shape fins are welded to the solar cell module plate mount and adhered to the bottom of the solar cell module plate to eliminate heat accumulated in the solar cell module plates and maintain the temperature of the solar cells therein under 80° C. The maintenance access is a space through which a worker may easily access the solar cell module plates to clean the surface thereof and also to replace the plates.

### BACKGROUND OF THE INVENTION

1. Field of Invention

Current application relates to a metal supporting frame structure to install solar cell module plates and incidental facilities on a house roof.

2. Description of the Prior Arts

Solar cells have become highly recognized as a clean energy source for individual houses because of the high price of electricity generated by fossil fuels and excessive generation of carbon dioxide. Returning of the nuclear powered electricity is considered but not welcomed in western society because of the safety issues of the power plant. Since the innovative development of photovoltaic solar cells by Chapin, et al. U.S. Pat. No. 2,780,765, many kinds of solar cells and methods of assembling the cells into a module, including but not limited to methods of assembling the solar cells for mounting on a house roof, have been introduced. However, these methods teach only how to assemble each solar cell and the parts to connect them in a planar shape. According to those illustrations, many heavy metal parts and ceramic insulators are necessary to make whole solar cell modules for mounting on the roof of a house. The final solar cell module for a house may be too heavy for the roof of an ordinary house. The heavy weight of the module along with its ancillaries could limit the number of module plates installed on a roof. In addition, it is not easy to clean the surface of the solar module plates. Accordingly, the efficiency of generation of electricity is decreased due to the polluted air and dusts of big cities. It is one of the purposes of the current application to mitigate such limitations.

The efficiency of a solar cell depends on the temperature of the solar cell body. Flora, et al. illustrates in their U.S. Pat. No. 2,763,882 that silicon P—N junction material has a higher rectifier efficiency at all temperatures up to about 220° C. But, a germanium rectifier, which is widely used for P—N—P junction composite for a solar cell, becomes quite inefficient at temperatures approaching 100° C. Consequently, rectifiers prepared from germanium must be cooled with great care in order to prevent the temperatures from exceeding a certain predetermined maximum, which is ordinarily about 80° C. In the desert area, temperatures usually reach up to 65° C. in the summer. Many patents are introduced to meet this requirement in such hot areas.

U.S. Pat. No. 4,056,405 to Varadi illustrates a panel for mounting solar energy cells with good heat conduction. The cells are mounted within the enclosure on a resinous cushion that is relatively a good conductor of heat but a poor conductor of electricity. U.S. Pat. No. 4,334,120 to Yamano, et al. illustrates an amorphous silicon solar cell, having a thickness thin enough to permit the sunlight to pass through, which is formed on the surface of a heat collecting plate attached to a heating medium tube. U.S. Pat. No. 4,361,717 Gilmore, et al. illustrates a large photovoltaic device area which is bonded to a highly pliable and thermally conductive structured copper strain relieving member; the lower face of the structured copper is sealed to a fluid cooled metal heat sink. U.S. Pat. No. 4,397,303 to Stultz illustrates a heat exchanger assembly for use with concentrating solar collectors. The heat exchanger includes a plurality of stacked heat conducting heat exchanger plates having grooves oriented to form flow passages extending in the direction of fluid flow.

Those solar cell modules are not the proper type for installing on the roof of private individual houses. Meanwhile, most of the solar cell modules that are up-to-date are simple-square plates equipped with terminals for electric connections. Workers install these modules on the sloped roof of individual houses directly.

U.S. Pat. No. 4,204,523 to Rothe illustrates a support for mounting solar energy collectors on the roof of a building, which has an opening in the roof sheeting and includes a shell having a generally flat rectangular base and an upstanding edge secured to, and extending to the periphery of the shell. The frame is configured so that it is dimensional to correspond to the outer surface shape of the roof sheeting and to permit making receipt thereof in the opening of the sheeting. The mounting support consists of a flat, rectangular shell having a shell edge and a shell bottom. An outer frame surrounds this flat shell, which its shape is adapted to the shape of the roof sheeting. Thereby the outer frame imitates the form of the often-used roof tiles or any other type of roof sheeting. This is to obtain an even seal off when inserting the outer frame into the existing roof sheeting. This follows in a manner in which the roofing tiles seal off one another. The purpose of this solar cell support is to seal off the openings of the roofing.

As reviewed from above, none of the prior arts illustrate a support frame structure for mounting solar cell modules on a house roof which maximizes the collecting ability of the solar energy by maintaining the cell temperature below 80° C.

### SUMMARY OF THE INVENTION

The purpose of the current application is to provide a supporting frame structure to render maximum solar energy collecting ability of solar cell modules. These solar cell modules are installed on a house roof. The purpose of the current application is also to provide environmental benefit to the neighborhoods. The support frame structure is comprised of aluminum pipes, steel pipes, plastic plates, and woods. The frame structure has at least four vertical posts made of metal pipes, which support other metal pipes, constituting a planar frame for the upper horizontal frame. A patio with a sloped top, at least 2 meters high, is developed between the roof of the house and the bottom of the top surface of the frame throughout the whole roof. This space is used to install incidental facilities of the solar power systems such as pumps, batteries, and water tanks and to maintain those facilities. As a result, the side view of the rooftop frame structure, on which the solar cell panels are mounted, forms a rectangular triangle on a square. The angle between the sloped surface and the horizontal base is 3 to 75 degrees, depending on the latitude of the geometric location of the place on which the solar cell plate modules are installed. Maintenance accesses, developed between the solar cell module mounts, enable frequent cleaning and maintenance of the solar cell modules. Pluralities of ‘T’ shape metal fins are installed across each solar cell module mount. The flat portion of the ‘T’ shape fin contacts with a rear surface of the solar cell module. The heat accumulated in the solar cell module is transferred to the surrounding air through the ‘T’ shape fins. The number of ‘T’ shape fins is adjusted to maintain the temperature of the solar cells below 80° C.

### BRIEF DESCRIPTION OF THE DRAWINGS

FIG. 1 is a perspective view of the solar cell module plate supporting frame structure.

FIG. 2 is an exploded view of the lower part of the solar cell module plate supporting frame structure.

FIG. 3 is a plain view of the solar cell module plate supporting frame structure.

FIG. 4 is a perspective cross sectional view along the A-A′ in FIG. 1 showing the relative position of solar cell module plate, ‘T’ shape fins, solar cell module mount, and maintenance access.

FIG. 5 is a front view of ‘T’ shape fins seen from point ‘C’ in FIG. 4, showing contacting mode the fins with solar cell module.

FIG. 6 is a side view of the solar cell module plate supporting frame structure showing the relative position of the top sloped surface and the horizontal base.

FIG. 7 is a front view of the whole solar cell module plate supporting frame structure of the current application seen from the direction B in the FIG. 1.

### DETAILED DESCRIPTION OF THE PREFERRED EMBODIMENT

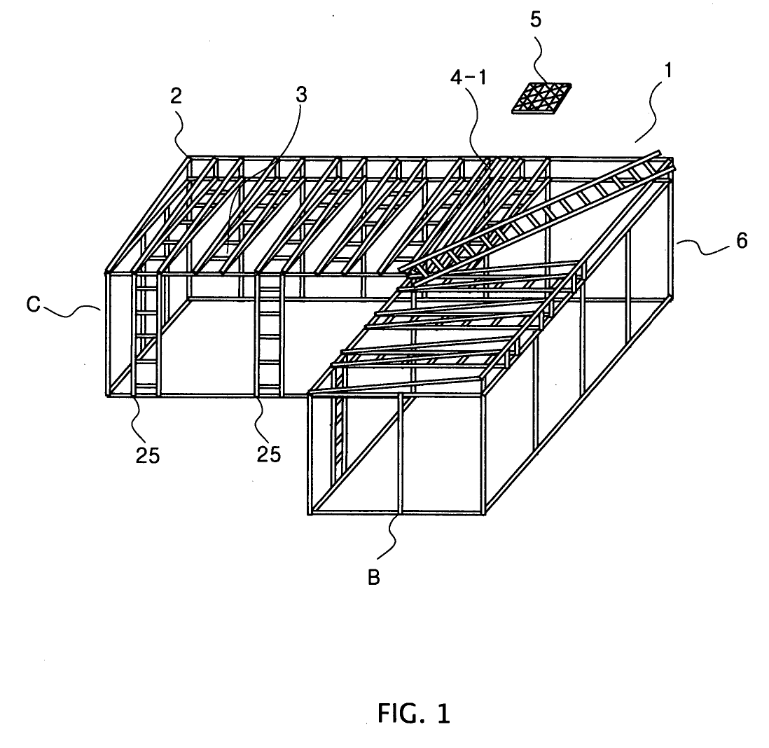

FIG. 1 is a perspective view of the solar cell module panel supporting frame structure (1) of the current application. The structure (1) is made of 5 cm by 5 cm (2 inch by 2 inch) square carbon steel pipes (2) welded to each other. Therefore, the structure (1) is self-sustaining. The upper face of the solar cell module panel supporting frame structure (1) is equipped with maintenance accesses (3) and solar cell module mounts (4). Pluralities of ‘T’ shape fins (4-1) are welded to the mount (4) and module plate (5). Solar cell module plates (5) of 180 cm by 76 cm are mounted on the mount (4) and supported by the ‘T’ shape fins (4-1). The ‘T’ shape fins (4-1) are soldered to the solar cell module plates (5) with thermal conductive solder (5-1), which is comprised of silver and/or lead.

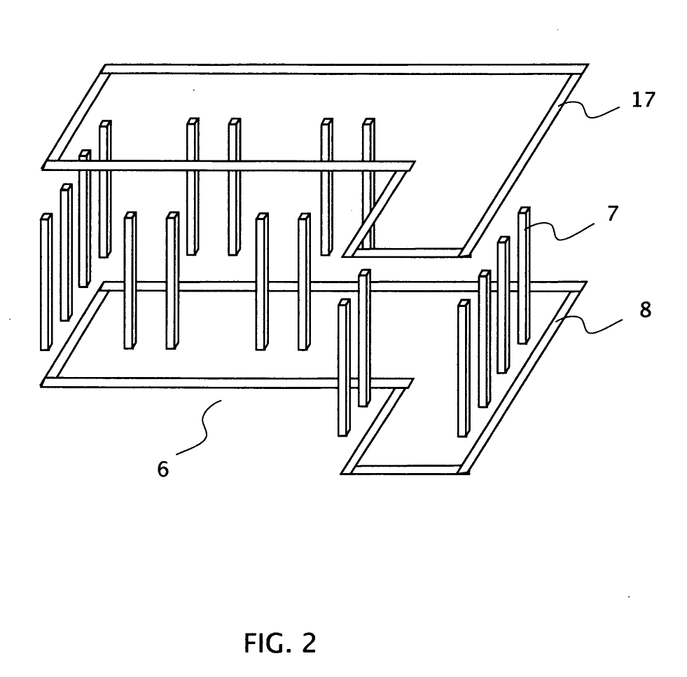

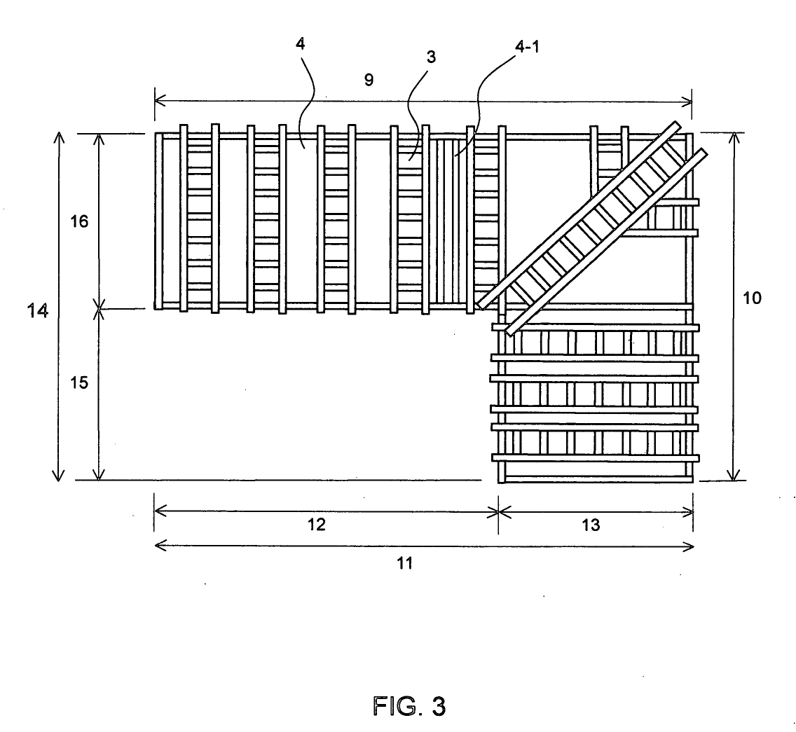

FIG. 2 is an exploded view of the lower part (6) of the solar cell module panel supporting frame structure (1). The lower part (6) of the structure (1) is in cubic form. Twenty 5 cm by 5 cm square carbon steel pipes (7) of 274 cm (9 feet) long are welded vertically on an “L” shape base (8) made with the same 5 cm by 5 cm square carbon steel pipes by cutting and welding 600 cm (20 feet) long stocks. The dimension of the “L” shape base (8) is seen in FIG. 3. The longest side (9) is 1,890 cm (63 feet). The second longest side (10) is 1,110 cm (37 feet). The side (11), facing the longest side (9), is divided into 1,230 cm (41 feet) long side (12) and 630 cm (21 feet) long side (13). The other side (14), facing the second longest side (10), is divided into 630 cm (21 feet) long side (15) and 480 cm (16 feet) long side (16). Another “L” shaped frame, made with the same geometry and dimension as the base (8), is made of the same material and is welded to the upper face of the twenty vertical carbon steel pipes (7) to form an upper base (17).

FIG. 3 is a plain view of the solar cell module panel supporting frame structure (1) showing the relative position of the maintenance accesses (3) and solar cell module mounts (4). The width of a solar cell module plate (5) mount (4) is 180 cm (6 feet). The width of a maintaining access (3) is 90 cm. The solar cell module mount (4) and the maintaining access (3) are installed side by side. The maintaining access (3) is formed by welding cross bars (3-1) across neighboring horizontal bases (17).

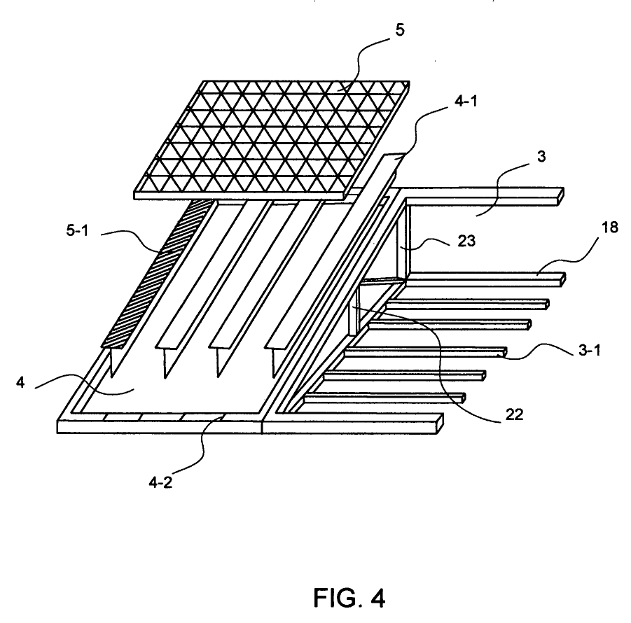

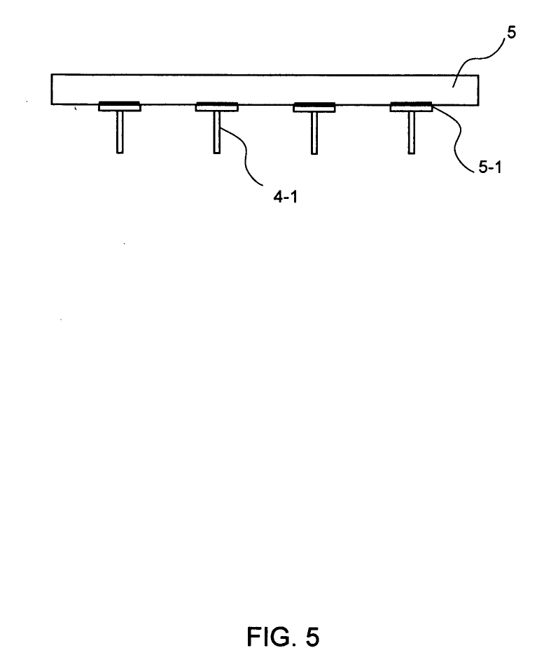

FIG. 4 is a perspective cross sectional view along the A-A′ in FIG. 1 showing the relative position of the maintenance access (3), the solar cell module mounts (4), ‘T’ shape fins (4-1) and the solar cell module plates (5). Pluralities of ‘T’ shape fins (4-1) are welded to the solar cell module mount (4) at the welding points (4-2) facing the protruded portion of the ‘T’ shape fins to the ground. Then the solar cell module plates (5) are soldered to the ‘T’ shape fins (4-1). Solders (5-1) with relatively low melting temperature, such as lead and/or silver, are used for soldering. The ‘T’ shape fins (4-1) not only transfer heat from the modules (5) to the air but also support the module (5) to be placed on the module mounts (4). FIG. 5 is a front view of ‘T’ shape fins (4-1) seen from point ‘C’ in FIG. 4, showing the contacting mode of the fins (4-1) to the solar cell module (5). When installing the solar cell module plates (5) on the mounts (4) and cleaning the module plates (5), a worker steps on the crossing bars (18) welded to the bottom of the neighboring mounts (4). Because the length of the arms of an average adult is 50 cm to 100 cm, and the width of the module plate (5) is 180 cm, it is very hard to clean the other side of the module plate (5). The layout of the current application allows a worker to approach both sides of every solar cell module plate (5) through the maintaining accesses (3) located on both sides of each mount (4). The maintaining accesses allows for frequent cleaning of the surface of every solar cell module plate (5) which increases the efficiency of collecting sunlight and electric power generating.

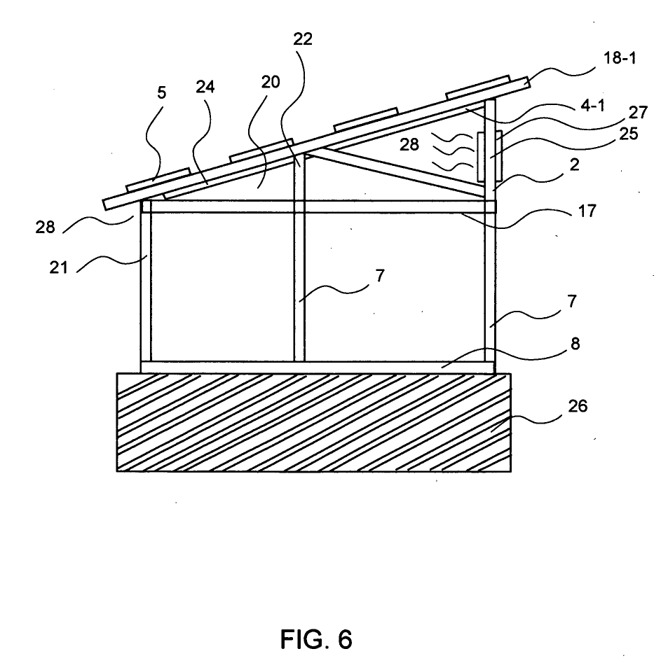

FIG. 6 is a side view of the solar cell module panel supporting frame structure (1), view from B and C in FIG. 1, showing the relative position of the top sloped surface (18-1) and the horizontal base (17). The overall shape of the side view is a rectangular triangle (20) mounted on a square (21). The triangle (20) shape is developed by adding a 30 cm to 90 cm long square metal pipe (2), (22) vertically to the vertical pipes (7), which are located on the longest side (9) and the second longest side (10). Then, by connecting them with another long metal pipe it becomes a sloped surface (18). As a result, the height of the vertical pipes located on both of the sides (9) and (10) becomes 360 cm to 390 cm. A vertical pipe (22) is located in the center of the horizontal base (17) and another crossing metal pipe (23) is added to form an equilateral triangle in the rectangular triangle (20). Side view of all the solar cell module mounts (4) has the same shape as an equilateral triangle in a rectangular triangle. This structure sustains the weight of the solar cell module plates (5) placed on the top sloped surface (18-1). The angle (24) between the horizontal base (17) and the top sloped surface (18-1) is 3 degrees to 75 degrees, depending on the latitude of the place on which the solar cell module plates (5) are installed.

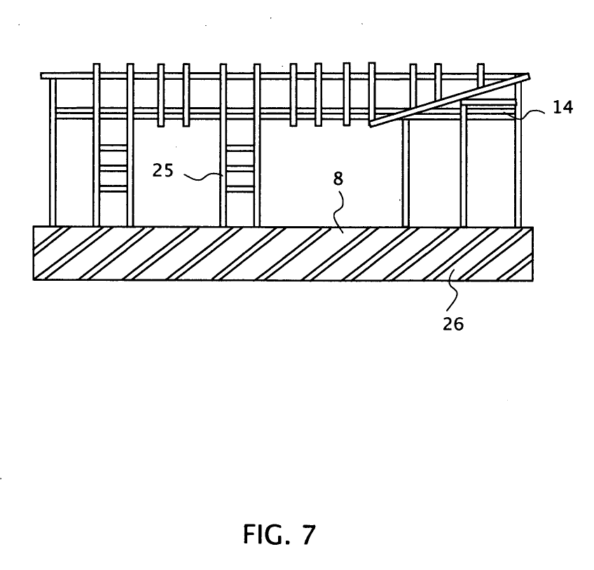

Each solar cell module mount (4) is equipped with at least one air blower (27) which is placed in the space under the solar cell module plate. The air blower (27) introduces air (28) into the space under the solar cell module plates (5). Then the air (28) flows between the blades of the ‘T’ shape fins (4-1) along the top sloped surface (18) and eliminates the heat from the solar cell module plates (5). FIG. 7 is a front view of the solar cell module plate supporting frame structure seen from direction B in the FIG. 1. Ladders (25) for climbing to the maintenance access (3) are shown. Two ladders are connected to the first and third maintenance accesses (3) from the left. The other ladder (25) attached to the eastern wing is not shown in FIG. 6. The whole structure is mounted on an existing house (26).

What is claimed is:

1. A supporting frame structure for solar cell module panels made of 5 cm by 5 cm square carbon steel pipes welded to each other for self-sustaining purposes is comprised of;
a lower part that is comprised of;
an “L” shape base that is made with the same 5 cm by 5 cm square carbon steel pipes, and
the longest side is 1,890 cm, and
the second longest side is 1,110 cm, and
the side facing the longest side is divided into a 1,230 cm long side and a 630 cm long side, and
the other side, facing the second longest side, is divided into a 630 cm long side and a 480 cm long side, and
twenty 5 cm by 5 cm square carbon steel pipes, 274 cm long, welded vertically on the “L” shape base, and
another “L” shape frame, having the same geometry and dimension as the “L” shape base, is made of the same material and welded to the upper face of the twenty vertical carbon steel pipes to form an upper base; and
pluralities of solar cell module plate mount made with the same 5 cm by 5 cm carbon steel pipes whose side view is developed as a rectangular triangle by adding a 60 cm to 90 cm long square metal pipe vertically to a vertical pipe, which is located on the longest side and adding a 30 cm to 60 cm long pipe vertically to a vertical pipe, which is located on the second longest side, and connecting them with another long metal pipe which constitutes a sloped surface; and the long metal pipe, constituting the sloped surface with an angle of 3 to 75 degree, aparts 180 cm of each other; and
pluralities of air blowers placed in a space of the solar cell module plate mount under a solar cell plate, and
pluralities of ‘T’ shape fins welded to the solar cell module plate mount facing the protruded portion of the ‘T’ shape fin to the ground, and
pluralities of maintaining access formed by welding cross bars across neighboring horizontal bases that are 90 cm apart.

2. A supporting frame structure for solar cell module panels made of claim 1, wherein the ‘T’ shape fins are soldered to solar cell module plates with silver solder.
